(19) United States
(12) Patent Application Publication
(10) Pub. No.: US 2026/0109225 A1
(43) Pub. Date: Apr. 23, 2026

(54) CONTENT PROVISION DEVICE, CONTENT PROVISION SYSTEM, AND RECORDING MEDIUM

(71) Applicant: TOYOTA BOSHOKU KABUSHIKI KAISHA, Aichi (JP)

(72) Inventors: Hikaru SATO, Aichi (JP); Osamu KAWASE, Aichi (JP); Nobuki HAYASHI, Aichi (JP); Hiroki ASHIZAWA, Aichi (JP); Tetsuro SAKAGUCHI, Aichi (JP); Yuki KAMIYA, Aichi (JP)

(73) Assignee: TOYOTA BOSHOKU KABUSHIKI KAISHA, Aichi (JP)

(21) Appl. No.: 19/361,107

(22) Filed: Oct. 17, 2025

(30) Foreign Application Priority Data
Oct. 18, 2024 (JP) 2024-184245

(51) Int. Cl. B60K 35/29

(52) U.S. Cl. CPC B60K 35/29; B60K 2360/741

(57) ABSTRACT

The content provision device includes a schedule determination section configured to determine a provision schedule for content so as to play back first content data associated with provision position information indicating a region where content is provided, from a timing when a movable body arrives at the provision region.

This Nonprovisional application claims priority under 35 U.S.C. § 119 on Patent Application No. 2024-184245 filed in Japan on Oct. 18, 2024, the entire contents of which are hereby incorporated by reference.

### TECHNICAL FIELD

The present disclosure relates to a content provision device, a content provision system, and a recording medium.

### BACKGROUND ART

Patent Literature 1 discloses a system configured to display, on a display section provided in a position visible to a passenger in a vehicle, content corresponding to the attributes of the passenger.

### Citation List

### Patent Literature

Patent Literature 1
Japanese Patent Application Publication Tokukai No. 2022-58312

### SUMMARY OF INVENTION

### Technical Problem

It is an object of an aspect of the present disclosure to suitably provide content in accordance with the attributes of a passenger riding in a movable body and a route along which the movable body travels.

### Solution to Problem

In order to solve the foregoing problem, a content provision device in accordance with an aspect of the present disclosure is a content provision device configured to cause an output device disposed inside a movable body to provide content for a passenger in the movable body, the content provision device including: a route obtaining section configured to obtain a route along which the movable body travels; an attribute obtaining section configured to obtain first attribute information indicating an attribute of the passenger in the movable body; a first storage section storing a plurality of pieces of content data including at least first content data associated with provision position information indicating a provision region where content is provided; and a schedule determination section configured to determine a provision schedule for one or more pieces of content provided to the passenger while the movable body is travelling along the route, wherein second attribute information indicating the attribute of an intended recipient of content is associated with each of the plurality of pieces of content data, and the schedule determination section is configured to: generate a first list of the first content data with the provision position information falling within a predetermined first distance from the route; and determine the provision schedule so that the first content data included in the first list is played back from a timing when the movable body arrives at the provision region indicated by the provision position information of the first content data.

The content provision device in accordance with each aspect of the present disclosure may be realized by a computer. In this case, the scope of the present disclosure also includes (i) a content provision program for a content provision device which program causes the computer to realize the content provision device by causing the computer to operate as the route obtaining section, the attribute obtaining section, the schedule determination section included in the content provision device with reference to the first storage section and (ii) a computer-readable recording medium storing the program.

### Advantageous Effects of Invention

According to an aspect of the present disclosure, it is possible to suitably provide content in accordance with the attributes of a passenger riding in a movable body and a route along which the movable body travels.

### BRIEF DESCRIPTION OF DRAWINGS

FIG. 1 is a view illustrating an example of a configuration of a content provision device in accordance with an embodiment of the present disclosure.

FIG. 2 is a view illustrating an example of arrangement of information terminals, each of which is an example of an output device.

FIG. 3 is a view illustrating an example of a configuration of an information terminal which is one example of an output device.

FIG. 4 is a control block diagram illustrating a content provision system in accordance with an embodiment of the present disclosure.

FIG. 5 is a view illustrating an example of a provision schedule for content.

FIG. 6 is a flowchart illustrating a flow of a process until determination of a provision schedule for content.

FIG. 7 is a flowchart illustrating an example of a process of a schedule determination section.

FIG. 8 is a flowchart of a process of a content provision device carried out after start of provision of content.

### DESCRIPTION OF EMBODIMENTS

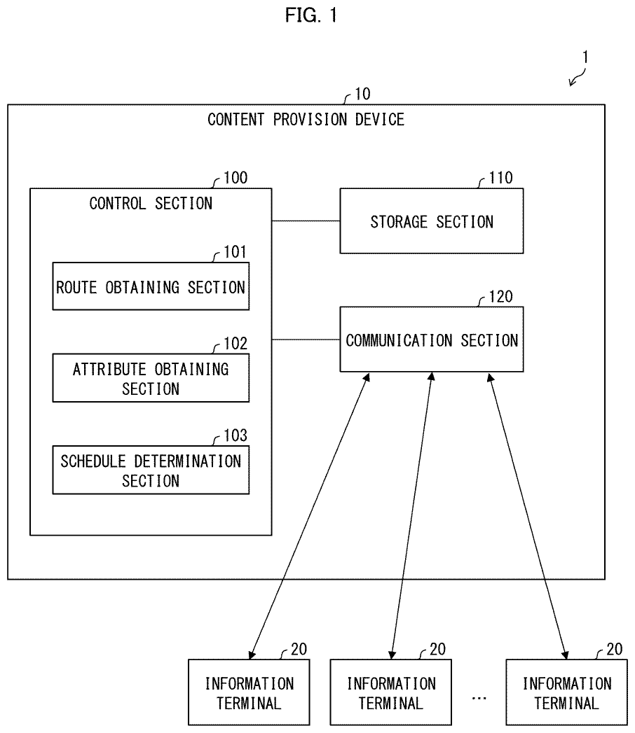

FIG. 1 is a view illustrating an example of a configuration of a content provision device in accordance with an embodiment of the present disclosure. A content provision device 10 illustrated in FIG. 1 is communicable with a plurality of information terminals 20, and determines a provision schedule for providing content for each of the plurality of information terminals 20. The term “content” here refers to one perceivable through the five senses of humans. The content includes, for example, a video, sound, vibration, scent, and mist. The plurality of information terminals 20 are output devices capable of providing at least video content. With the plurality of information terminals 20, the content is provided on the basis of the provision schedule determined for each information terminal 20.

The content provision device 10 is, for example, a server. The content provision device 10 includes a control section 100, a storage section 110, and a communication section 120. The control section 100 is constituted by, for example, a central processing unit (CPU) and a main storage device. The storage section 110 is constituted by, for example, a hard disk drive (HDD) or a solid state drive (SSD). The communication section 120 is an interface used for communication with the plurality of information terminals 20.

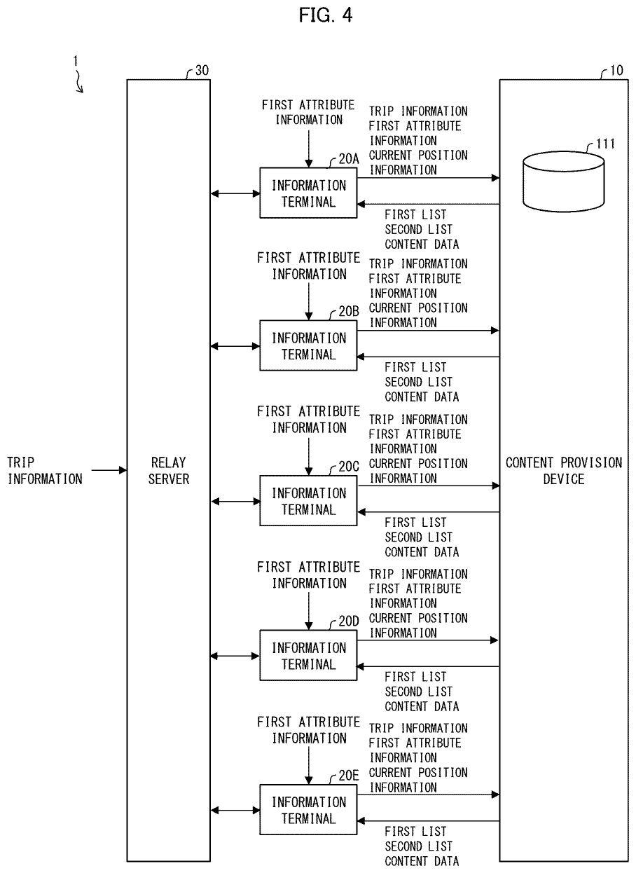

The control section 100 of the content provision device 10 carries out a content provision program stored in the storage section 110 to function as a route obtaining section 101, an attribute obtaining section 102, and a schedule determination section 103. The route obtaining section 101, the attribute obtaining section 102, and the schedule determination section 103 will be described later with reference to FIG. 4.

The information terminals 20 are each an example of an output device, and are, for example, tablet terminals, personal computers, or smartphones. Each of the information terminals 20 is disposed inside a movable body. Examples of the movable body include vehicles such as automobiles, buses, and taxis, ships, and aircrafts. The plurality of information terminals 20 illustrated in FIG. 1 do not need to be all disposed inside the same movable body and may be disposed inside different movable bodies.

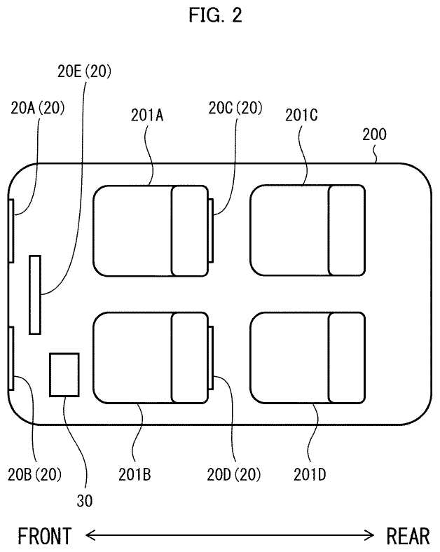

FIG. 2 is a view illustrating an example of arrangement of the information terminals 20. FIG. 2 illustrates a layout in the cabin of a vehicle 200 which is one example of a movable body. The vehicle 200 illustrated in FIG. 2 is, for example, a shuttle bus used for transportation services. In the cabin of the vehicle 200, a plurality of seats 201A, 201B, 201C, and 201D, on which passengers can be seated, are disposed. In the following description, the travelling direction of the vehicle 200 is defined as the front, as indicated by the arrow in FIG. 2. The seats 201A and 201B are the foremost seats in the vehicle 200. The seat 201C is disposed so as to follow the seat 201A, and the seat 201D is disposed so as to follow the seat 201B.

In the cabin of the vehicle 200, tablet terminals 20A, 20B, 20C, 20D, and 20E which are examples of the information terminals 20 are disposed. The tablet terminals 20A, 20B, 20C, and 20D are disposed so as to be located in front of the passengers seated on the seats 201A, 201B, 201C, and 201D, respectively. For example, the tablet terminal 20A is disposed on the inner wall of the vehicle 200 that is located in front of the seat 201A. The tablet terminal 20C is disposed on the backrest of the seat 201A that is located in front of the seat 201C. The tablet terminal 20E is disposed, for example, in a position easily visible to the passengers seated on any of the seats 201A, 201B, 201C, and 201D. The tablet terminal 20E is, for example, fixed to the ceiling of the vehicle 200.

In a case where the content provision device 10 is disposed outside the vehicle 200, the information terminals 20 communicate with the content provision device 10 via a network, such as a wireless communication network, the Internet, or a telephone line network. In a case where the content provision device 10 is disposed in the cabin of the vehicle 200, the information terminals 20 may communicate with the content provision device 10 through short-range wireless communication.

To the vehicle 200 illustrated in FIG. 2, a relay server 30 is disposed. The relay server 30 provides the information terminals 20 with, for example, reservation information for the seats 201A, 201B, 201C, and 201D of the vehicle 200 and trip information, on the planned travelling of the vehicle 200, indicating a departure point, a destination point, and a relay point. The relay point is, for example, a location where passengers with reservations for the seats 201A, 201B, 201C, and 201D board the vehicle 200. The relay server 30 also has a function of providing various services in cooperation with an external application programming interface (API).

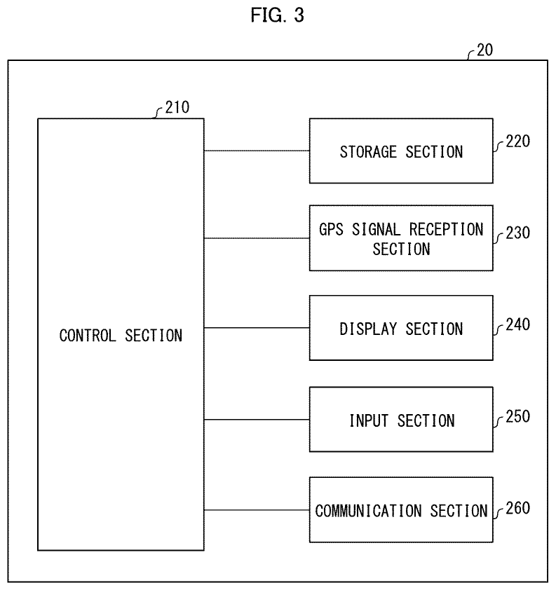

FIG. 3 is a view illustrating an example of a configuration of each information terminal 20. The information terminal 20 includes, for example, a control section 210, a storage section 220, a GPS signal reception section 230, a display section 240, an input section 250, and a communication section 260. The control section 210 is constituted by, for example, a central processing unit (CPU) and a main storage device. The storage section 220 is constituted by, for example, a hard disk drive (HDD) or a solid state drive (SSD). The GPS signal reception section 230 receives a signal from a GPS satellite. The display section 240 is, for example, a display and is used for providing content, such as still images or moving images. The input section 250 includes, for example, keys, buttons, a pointing device, a touch panel, and is used for inputting information. The communication section 260 is an interface used for communication with the content provision device 10 and the relay server 30.

FIG. 4 is a block diagram illustrating a content provision system 1 in the vehicle 200 illustrated in FIG. 2. Hereinafter, the route obtaining section 101, the attribute obtaining section 102, and the schedule determination section 103 illustrated in FIG. 1 will be described with reference to FIG. 4.

### Route Obtaining Section

The route obtaining section 101 obtains a route along which the vehicle 200 travels from a departure point to a destination point via a relay point. For example, the route obtaining section 101 obtains trip information provided by the relay server 30, via the tablet terminal 20E or the like, and obtains route information indicating a route along which the vehicle 200 travels, on the basis of the trip information. The route obtaining section 101 acquires route information with use of a map application, such as Google Maps. The route information includes planned arrival time points at locations on the route, such as a relay point and a destination point. The route obtaining section 101 may obtain the shortest route from the departure point to the destination point included in the trip information with use of a route search algorithm such as Dijkstra's algorithm.

The route obtaining section 101 further obtains current position information on a current position of the vehicle 200. For example, the route obtaining section 101 obtains, as the current position information, the GPS signal received by an information terminal 20 via the GPS signal reception section 230 or the current position of the vehicle 200 calculated on the basis of the GPS signal, from the information terminal 20. The route obtaining section 101 may obtain the current position information from each of the plurality of information terminals 20, or may obtain the current position information from one of the plurality of information terminals 20 (for example, the tablet terminal 20E). The route obtaining section 101 may update the route information on the basis of the current position information of the vehicle 200. For example, in a case where the current position of the vehicle 200 is deviating from the route, the route obtaining section 101 may update the route information to indicate a route passing the current position of the vehicle 200.

### Attribute Obtaining Section

The attribute obtaining section 102 obtains first attribute information indicating the attributes of each passenger in the vehicle 200. The first attribute information includes, for example, the gender, age, purpose, and residence of each passenger. When a passenger seated on the seat 201A activates the tablet terminal 20A, a screen for inputting the first attribute information is displayed on the display section 240 of the tablet terminal 20A. The content provision device 10 obtains, from the tablet terminal 20A, the first attribute information selected by the passenger with use of the input section 250 of the tablet terminal 20A. The gender attribute of the passenger is selected from, for example, options “male”, “female”, and “no response”. The age attribute of the passenger is selected from options such as “teens”, “twenties”, “thirties”, “forties”, “fifties”, “sixties”, and “seventies or older”. The purpose attribute of the passenger is selected from options such as “for tourism purposes” and “for business purposes”. The residence of the passenger is selected from options such as “domestic location” and “overseas location”.

The content provision system 1 may request input of the first attribute information when a seat is reserved. In a case where the first attribute information is inputted at the time of seat reservation, the first attribute information may be provided to the information terminal 20 from the relay server 30 together with the trip information.

### Schedule Determination Section

The schedule determination section 103 determines a provision schedule for one or more pieces of content provided to the passenger while the vehicle 200 is moving along the route obtained by the route obtaining section 101. The content is provided by playing back content data stored in a content database 111 with use of, for example, the display sections 240 of the information terminals 20. The provision schedule is information that specifies the order of the pieces of content to be provided from each information terminal 20. The provision schedule is, for example, a playback list of content data in which the timings and order of the playbacks are specified in advance.

The content database 111 is stored in, for example, the storage section 110 illustrated in FIG. 1. In a case where the content database 111 is stored in the storage section 110, the storage section 110 is an example of a first storage section. Every content data stored in the content database 111 is associated with second attribute information indicating the attributes of an intended recipient of content. The intended recipient of the content refers to a person who is included in the target audience to which the creator of the content aimed to provide the content. The content data stored in the content database 111 includes first content data that is associated with provision position information indicating a region where content is provided and second content data associated with no provision position information indicating a region where content is provided. The first content data is content data for providing content regarding a predetermined location on the map. The provision position information is, for example, information indicating a specific location on a map, e.g., latitude and longitude. The second content data is, for example, data of advertising content.

The schedule determination section 103 selects, from the content database 111, the first content data and the second content data to be played back by each information terminal 20. The schedule determination section 103 generates a first list which is a list of the selected first content data to be played back, and a second list which is a list of the selected second content data to be played back. The first list and the second list generated by the schedule determination section 103 are transmitted to the information terminal 20. The information terminal 20 plays back the first content data and the second content data on the basis of the first list and the second list.

The first list includes, for example, first content data falling within a predetermined first distance from the route obtained by the route obtaining section 101, among the first content data stored in the content database 111. The second list includes, for example, data with the second attribute information identical to or similar to the first attribute information obtained by the attribute obtaining section 102, among the second content data stored in the content database 111. The first list and the second list are generated for each passenger.

The schedule determination section 103 calculates an attribute score indicating a degree of similarity between the first attribute information obtained by the attribute obtaining section 102 and the second attribute information associated with each second content data. If an attribute included in the first attribute information is included in the second attribute information associated with the second content data, the attribute score increases by a predetermined amount. For example, in a case where the age attribute in the first attribute information is twenties, and the age attribute in the second attribute information includes twenties, the attribute score of the second content data increases by a predetermined amount.

The amount by which the attribute score increases when the first attribute information and the second attribute information match may vary depending on the attribute. For example, the increasing amounts for the gender attribute and for the residence attribute may be each larger than that for the age attribute and that for the purpose attribute. The second content data to be included in the second list may be limited to those having at least a gender attribute and residence attribute that match those of the first attribute information obtained by the attribute obtaining section 102. In the second list, pieces of second content data are stored in descending order of the attribute scores thereof. When playing back the second content data, the information terminal 20 makes it possible to provide content more suited to the attributes of the passenger by playing back the pieces of second content data in the order in which they are stored in the second list.

In the first list, pieces of first content data are sorted in the order of proximity thereof to the departure point along the route obtained by the route obtaining section 101. According to the provision schedule for the content, when the current position of the vehicle 200 arrives at the region where first content data included in the first list is provided, the information terminal 20 is caused to play back the first content data. The current position of the vehicle 200 can be detected on the basis of the GPS signal received by the GPS signal reception section 230.

The information terminals 20 play back the second content data while none of the first content data is being played back. The number of pieces of second content data to be included in the second list may be determined on the basis of a time difference Δt between a travelling time required for the vehicle 200 to arrive at the destination point and a first total playback time for the first content data included in the first list. For example, the second content data may be included in the second list so that a second total playback time for the second content data to be included in the second list is equal to or greater than the time difference Δt. The second total playback time for the second content data included in the second list may be shorter than the time difference Δt. In a case where the second total playback time is shorter than the time difference Δt, the second content data included in the second list may be played back repeatedly according to need.

The schedule determination section 103 may also calculate an attribute score indicating a degree of similarity between the second attribute information associated with each first content data included in the first list and the first attribute information obtained by the attribute obtaining section 102. The schedule determination section 103 may narrow down the first content data to be included in the first list on the basis of the attribute score. For example, in a case where the timings when a plurality of pieces of first content data are played back overlap, the first content data to be included in the first list may be narrowed down on the basis of the attribute score of each first content data.

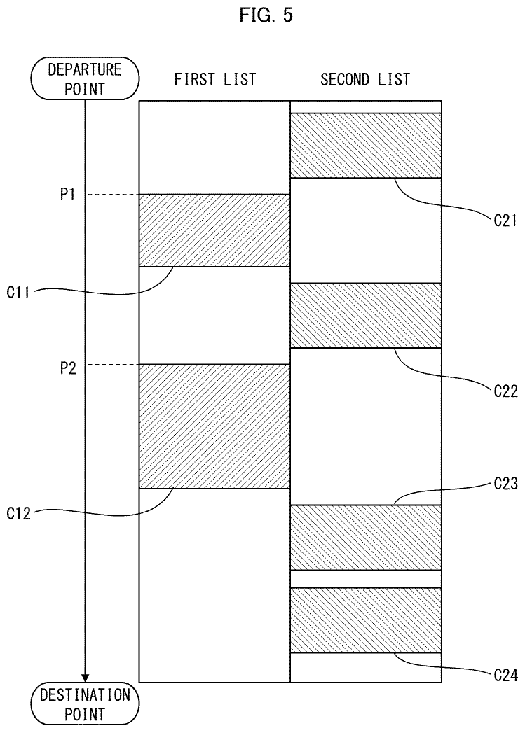

The first list and the second list generated by the schedule determination section 103 are an example of the provision schedule for content. FIG. 5 is a view used for explaining a method for providing content on the basis of the first list and the second list.

In FIG. 5, the first list generated by the schedule determination section 103 includes pieces of first content data C11 and C12 in this order. The second list generated by the schedule determination section 103 includes pieces of second content data C21, C22, C23, and C24 in this order.

Until the vehicle 200 arrives at a point P1, the vehicle 200 is not located within any region where the first content data included in the first list is provided, and thus the information terminal 20 plays back the second content data C21 included in the second list.

When the vehicle 200 arrives at the point P1, the vehicle 200 enters the region where the first content data C11 is provided, and thus the information terminal 20 starts to play back the first content data C11. On completion of the playback of the first content data C11, the information terminal 20 plays back the second content data C22 included second in the second list.

When the vehicle 200 arrives at the point P2, the vehicle 200 enters the region where the first content data C12 is provided, and thus the information terminal 20 starts to play back the first content data C12. On completion of the playback of the first content data C12, the information terminal 20 plays back the second content data C23 included third in the second list.

At the timing when the playback of the second content data C23 is completed, the vehicle 200 has not arrived at the destination point, and all the first content data included in the first list has been played back. Therefore, the information terminal 20 plays back the second content data C24 included fourth in the second list. In a case where two pieces of second content data are played back in succession, the information terminal 20 may have a predetermined cool time provided between the playbacks of the two.

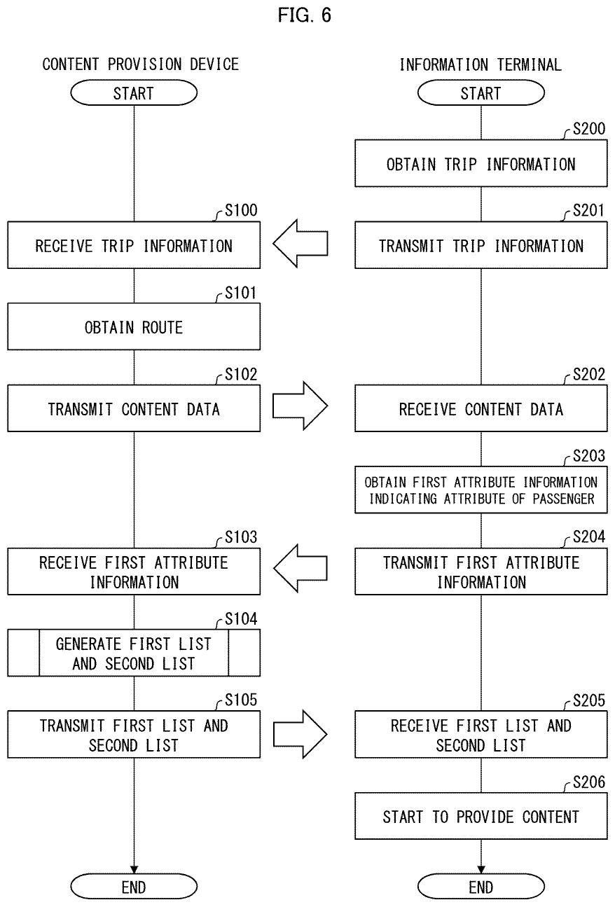

FIG. 6 is a flowchart illustrating a flow of a process until determination of a provision schedule for content. In a case where each information terminal 20 is activated by a passenger in the vehicle 200, the control section 210 of the information terminal 20 communicates with the relay server 30 via the communication section 260 to obtain trip information from the relay server 30 (S200). The control section 210 of the information terminal 20 transmits the trip information obtained from the relay server 30, to the content provision device 10 (S201).

When the control section 100 of the content provision device 10 receives the trip information transmitted from the information terminal 20 (S100), the control section 100 functions as the route obtaining section 101 to obtain the route along which the vehicle 200 travels, on the basis of the trip information (S101).

The control section 100 of the content provision device 10 transmits the content data to the information terminal 20 on the basis of the route along which the vehicle 200 travels (S102). In S102, the content data transmitted by the content provision device 10 to the information terminal 20 includes at least first content data falling within a predetermined second distance from the route obtained by the route obtaining section 101. The second distance is set to a value at least longer than the first distance. The route obtained by the route obtaining section 101 may be updated, for example, in a case where the current position of the vehicle 200 deviates from the route. When the route is updated after the vehicle 200 starts to travel, the first content data to be played back by the information terminal 20 may change. The first content data falling within a predetermined second distance from the route obtained by the route obtaining section 101 is transmitted in advance, so that even in a case where the route is updated, it is possible to play back, without delay, the first content data with the provision region near the route that has been updated. The control section 210 of the information terminal 20 receives the content data transmitted in S102 (S202).

The control section 210 of the information terminal 20 obtains first attribute information indicating the attributes of the passenger in the vehicle 200 (S203). For example, the control section 210 of the information terminal 20 causes the display section 240 of the information terminal 20 to display an input screen for inputting the first attribute information, and obtains the first attribute information inputted by the passenger with use of the input section 250. The control section 210 of the information terminal 20 transmits the obtained first attribute information to the content provision device 10 (S204). The control section 210 of the information terminal 20 may carry out the process of S203 at any timing that falls between the processes of S201 and S204, and may carry out the process of S203 in parallel with the process of S202.

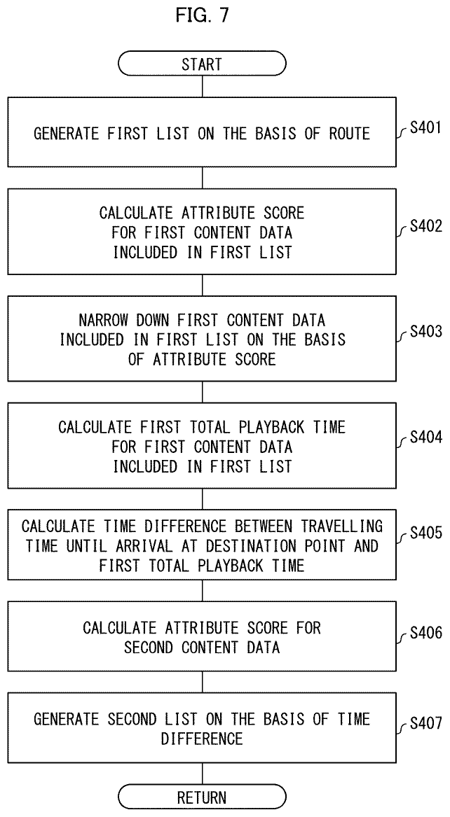

The control section 100 of the content provision device 10 functions as the attribute obtaining section 102 and receives the first attribute information transmitted by the information terminal 20 (S103). The control section 100 of the content provision device 10 functions as the schedule determination section 103 to generate the first list and the second list on the basis of the route obtained in S101 and the first attribute information received in S103 (S104). The process of S104 will be described later with reference to FIG. 7. After generation of the first list and the second list, the control section 100 of the content provision device 10 transmits the provision schedule including at least the first list and the second list to the information terminal 20 (S105). On receiving the first list and the second list transmitted in S105 (S205), the information terminal 20 starts to provide the content (S206).

FIG. 7 is a flowchart illustrating an example of a process of the schedule determination section 103. The process illustrated in FIG. 7 is carried out in, for example, S104 of FIG. 6 by the control section 100 of the content provision device 10. In S401, the schedule determination section 103 generates the first list on the basis of the route obtained by the route obtaining section 101. The schedule determination section 103 extracts, for example, first content data within a predetermined first distance from the route from among the first content data stored in the content database 111. The schedule determination section 103 rearranges the pieces of first content data extracted, in order of proximity thereof to the departure point along the route.

In S402, the schedule determination section 103 calculates an attribute score on the basis of the second attribute information associated with each first content data included in the first list generated in S401 and the first attribute information obtained by the attribute obtaining section 102.

In S403, the schedule determination section 103 narrows down the first content data included in the first list, on the basis of the attribute scores calculated in S402. For example, the schedule determination section 103 detects, from the first list, a plurality of pieces of first content data with overlapping playback periods. The schedule determination section 103 retains the first content data with a higher attribute score in the first list, and excludes the first content data with a lower attribute score from the first list.

In S404, the schedule determination section 103 calculates a first total playback time for the first content data included in the first list. In subsequent S405, the schedule determination section 103 calculates a time difference Δt between a travelling time until the vehicle 200 that travels along the route arrives at the destination point and the first total playback time.

In subsequent S406, the schedule determination section 103 calculates an attribute score between the first attribute information obtained by the attribute obtaining section 102 and the second attribute information associated with each second content data.

In subsequent S407, the schedule determination section 103 generates the second list on the basis of the time difference Δt calculated in S405 and the attribute score calculated in S406 for each second content data. For example, the schedule determination section 103 adds the second content data to the second list in descending order of the attribute scores until the second total playback time for the second content data included in the second list exceeds the time difference Δt. On completion of generation of the second list, the schedule determination section 103 ends the process illustrated in FIG. 7.

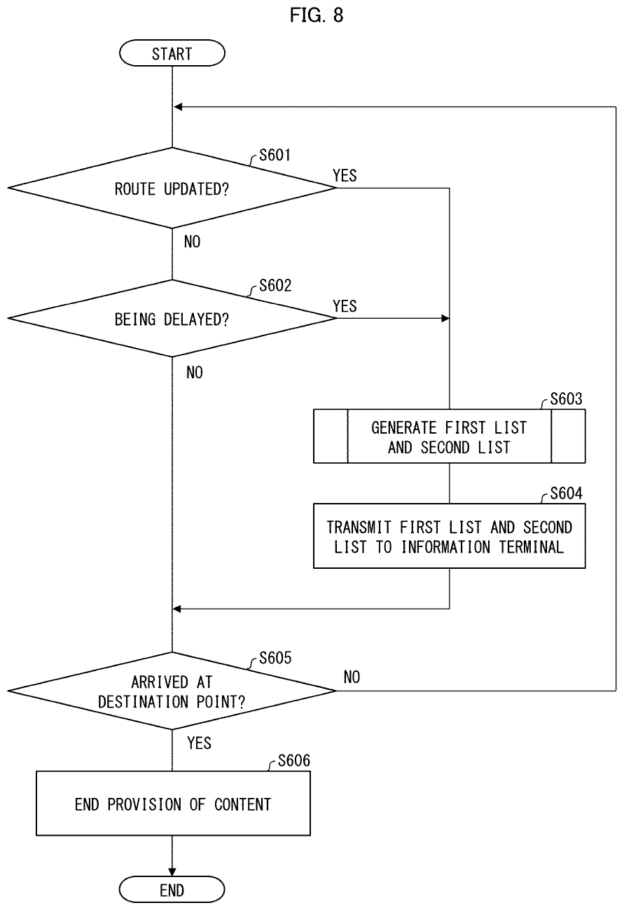

FIG. 8 is a flowchart of a process of the content provision device 10 carried out after start of provision of the content by the information terminals 20 in S206 of FIG. 6. In S601, the control section 100 of the content provision device 10 determines whether or not the route has been updated by the route obtaining section 101. In a case where the route has been updated (S601: YES), the control section 100 of the content provision device 10 advances to the process of S603. In a case where the route has not been updated (S601: NO), the control section 100 of the content provision device 10 advances to S602.

In S602, the control section 100 of the content provision device 10 determines whether or not the vehicle 200 is travelling later than planned. The control section 100 of the content provision device 10 obtains, from the route information, a planned time point at which the vehicle 200 is expected to arrive at the current position, and compares it with the current time. In a case where the current time is past the planned time point by a predetermined time or more, the control section 100 of the content provision device 10 determines that the vehicle 200 is travelling later than planned (S602: YES). In a case where the vehicle 200 is travelling later than planned (S602: YES), the control section 100 of the content provision device 10 advances to the process of S603. In a case where the vehicle 200 is not travelling later than planned (S602: NO), the control section 100 of the content provision device 10 advances to S605.

In S603, on the basis of the updated route, the control section 100 of the content provision device 10 carries out the process illustrated in FIG. 7 to generate the first list and the second list. In subsequent S604, the control section 100 of the content provision device 10 transmits the first list and the second list to each information terminal 20. The information terminal 20 receives the first list and the second list transmitted in S604, and starts to provide content with use of the received first list and second list.

In S605, the control section 100 of the content provision device 10 determines whether or not the vehicle 200 has arrived at the destination point. In a case where the vehicle 200 has arrived at the destination point (S605: YES), the control section 100 of the content provision device 10 ends provision of the content using the information terminal 20 (S606). In a case where the vehicle 200 has not arrived at the destination point (S605: NO), the control section 100 of the content provision device 10 advances to the process of S601.

### Variations

In the embodiment above, the first content data is content data for providing content regarding a predetermined location on the map, but this should not be construed as a limitation. For example, it may include content data such as content describing a travelling route which is played back at a departure point or a relay point, or content describing arrival at a destination point.

In the embodiment above, the schedule determination section 103 generates the first list and the second list, and each information terminal 20 plays back the first content data and the second content data on the basis of the first list and the second list, respectively. However, the schedule determination section 103 may not generate the second list, provided that the schedule determination section 103 generates at least the first list. In a case where the schedule determination section 103 does not generate the second list, it is sufficient that each information terminal 20 plays back the first content data on the basis of the first list. For example, the information terminal 20 plays back the first content data included in the first list, from a timing when the vehicle 200 arrives at the provision region indicated by each provision position information, and may play back no content data while none of the first content data is being played back.

### Software Implementation Example

The functions of the content provision device 10 (hereinafter, referred to as “device”) can be realized by a program for causing a computer to function as the device, the program causing the computer to function as the control blocks of the device (in particular, the components included in the control section 100).

In this case, the device includes, as hardware for executing the program, a computer which includes at least one control device (e.g., processor) and at least one storage device (e.g., memory). Each function described in the foregoing embodiments can be realized by the control device and the storage device executing the program.

The program may be stored in one or more non-transitory computer-readable recording media. This recording medium may or may not be provided in the device. In the latter case, the program can be supplied to or made available to the device via any transmission medium such as a wired transmission medium or a wireless transmission medium.

Further, some or all of functions of the control blocks can be realized by a logic circuit. For example, the present disclosure encompasses, in its scope, an integrated circuit in which a logic circuit that functions as each of the control blocks is formed. As another alternative, for example, it is possible to realize the functions of the control blocks by a quantum computer.

Further, each of processes which are described in the foregoing embodiments may be carried out by artificial intelligence (AI). In this case, the AI may be operated by the control device, or alternatively operated by another device (e.g., an edge computer, a cloud server).

The present disclosure is not limited to the embodiments above, but can be altered in various ways by a skilled person in the art within the scope of the claims. The present disclosure also encompasses, in its technical scope, any embodiment derived by combining technical means disclosed in differing embodiments as appropriate.

Aspects of the present invention can also be expressed as follows:

A content provision device in accordance with Aspect 1 of the present disclosure is a content provision device configured to cause an output device disposed inside a movable body to provide content for a passenger in the movable body, the content provision device including: a route obtaining section configured to obtain a route along which the movable body travels; an attribute obtaining section configured to obtain first attribute information indicating an attribute of the passenger in the movable body; a first storage section storing a plurality of pieces of content data including at least first content data associated with provision position information indicating a provision region where content is provided; and a schedule determination section configured to determine a provision schedule for one or more pieces of content provided to the passenger while the movable body is travelling along the route, wherein second attribute information indicating the attribute of an intended recipient of content is associated with each of the plurality of pieces of content data, and the schedule determination section is configured to: generate a first list of the first content data with the provision position information falling within a predetermined first distance from the route; and determine the provision schedule so that the first content data included in the first list is played back from a timing when the movable body arrives at the provision region indicated by the provision position information of the first content data.

According to the configuration above, it is possible to suitably provide content in accordance with the attribute of the passenger riding in the movable body and the route along which the movable body travels.

A content provision device in accordance with Aspect 2 of the present disclosure is configured, in Aspect 1 above, such that: the plurality of pieces of content data stored in the first storage section further include second content data to which no provision region where content is provided is set in advance; and the schedule determination section is configured to: further generate a second list of the second content data with the second attribute information identical to or similar to the first attribute information; and determine the provision schedule so that the second content data included in the second list is played back while the first content data is not being played back.

According to the configuration above, even while the first content data is not being played back, it is possible to suitably provide content in accordance with the attribute of the passenger in the movable body.

A content provision device in accordance with Aspect 3 of the present disclosure is configured, in Aspect 1 above, such that the schedule determination section narrows down the first content data to be included in the first list, on the basis of the second attribute information associated with the first content data.

In a case where the first content data is scheduled to be played back on the basis of the provision position information, pieces of first content data may have overlapping playback periods. According to the configuration above, the first content data to be included in the first list is narrowed down on the basis of the second attribute information associated with the first content data, so that it is possible to reduce a possibility of the overlapping of the playback periods.

A content provision system in accordance with Aspect 4 of the present disclosure includes: the content provision device in accordance with any one of Aspects 1 to 3 above; and a plurality of the output devices, the attribute obtaining section obtaining the first attribute information of the passenger using each of the plurality of the output devices, the schedule determination section determining a provision schedule for the passenger using each of the plurality of the output devices.

According to the configuration above, it is possible to suitably provide content matching the respective attributes of a plurality of passengers riding in the movable body and corresponding to the route along which the movable body travels, to the passengers.

A content provision system in accordance with Aspect 5 of the present disclosure is configured, in Aspect 4 above, such that: the route obtaining section is able to update the route while the movable body is travelling; the schedule determination section updates at least the first list in a case where the route obtaining section has updated the route or in a case where travelling of the movable body is being delayed; each of the plurality of the output devices further includes a second storage section; and the content provision device causes, before the schedule determination section determines the provision schedule, the second storage section to store the first content data with the provision position information falling within a second distance longer than the first distance from the route.

According to the configuration above, the second storage section is caused to store in advance first content data falling within a second distance from the route before the schedule determination section determines the provision schedule, so that it is possible to provide the first content data without delay, even in a case where, for example, the route is updated.

A content provision program in accordance with Aspect 6 of the present disclosure causes the content provision device in accordance with Aspect 1 to refer to the first storage section to cause a computer to function as the route obtaining section, the attribute obtaining section, and the schedule determination section.

According to the configuration above, it is possible to suitably provide content in accordance with the attribute of the passenger riding in the movable body and the route along which the movable body travels.

### Reference Signs List

1 Content provision system
10 Content provision device
20 Information terminal (output device)
20A, 20B, 20C, 20D, 20E Tablet terminal (output device)
100, 210 Control section
101 Route obtaining section
102 Attribute obtaining section
103 Schedule determination section
110, 220 Storage section
111 Content database
200 Vehicle
240 Display section
C11, C12 First content data
C21, C22, C23, C24 Second content data

1. A content provision device configured to cause an output device disposed inside a movable body to provide content for a passenger in the movable body, the content provision device comprising:
a route obtaining section configured to obtain a route along which the movable body travels;
an attribute obtaining section configured to obtain first attribute information indicating an attribute of the passenger in the movable body;
a first storage section storing a plurality of pieces of content data including at least first content data associated with provision position information indicating a provision region where content is provided; and
a schedule determination section configured to determine a provision schedule for one or more pieces of content provided to the passenger while the movable body is travelling along the route, wherein
second attribute information indicating the attribute of an intended recipient of content is associated with each of the plurality of pieces of content data, and
the schedule determination section is configured to:
generate a first list of the first content data with the provision position information falling within a predetermined first distance from the route; and
determine the provision schedule so that the first content data included in the first list is played back from a timing when the movable body arrives at the provision region indicated by the provision position information of the first content data.

2. The content provision device according to claim 1, wherein:
the plurality of pieces of content data stored in the first storage section further include second content data to which no provision region where content is provided is set in advance; and
the schedule determination section is configured to:
further generate a second list of the second content data with the second attribute information identical to or similar to the first attribute information; and
determine the provision schedule so that the second content data included in the second list is played back while the first content data is not being played back.

3. The content provision device according to claim 1, wherein the schedule determination section narrows down the first content data to be included in the first list, on the basis of the second attribute information associated with the first content data.

4. A content provision system comprising:
the content provision device according to claim 1; and
a plurality of the output devices,
the attribute obtaining section obtaining the first attribute information of the passenger using each of the plurality of the output devices,
the schedule determination section determining a provision schedule for the passenger using each of the plurality of the output devices.

5. The content provision system according to claim 4, wherein:
the route obtaining section is able to update the route while the movable body is travelling;
the schedule determination section updates at least the first list in a case where the route obtaining section has updated the route or in a case where travelling of the movable body is being delayed;
each of the plurality of the output devices further includes a second storage section; and
the content provision device causes, before the schedule determination section determines the provision schedule, the second storage section to store the first content data with the provision position information falling within a second distance longer than the first distance from the route.

6. A non-transitory computer-readable recording medium that stores a program for causing a computer to function as the content provision device according to claim 1, the program causing the computer to function as the route obtaining section, the attribute obtaining section, and the schedule determination section with reference to the first storage section.
